(19) United States
(12) Patent Application Publication
(10) Pub. No.: US 2012/0311876 A1
(43) Pub. Date: Dec. 13, 2012

(54) CUTTING ELEMENT

(75) Inventor: Xiaofeng Zhang, Nanjing (CN)

(73) Assignee: CHERVON (HK) LIMITED, Wanchai (HK)

(21) Appl. No.: 13/486,055

(22) Filed: Jun. 1, 2012

(30) Foreign Application Priority Data
Jun. 10, 2011 (CN) 201110155551.1

(51) Int. Cl. B23D 61/00

(52) U.S. Cl. 30/347

(57) ABSTRACT

A cutting element adapted for use with an oscillating power tool having an output shaft that makes an oscillating movement about its own axis. The cutting element has a longitudinally extending main body, a mounting hole and a cutting portion for acting upon a workpiece to be processed. The mounting hole is disposed at a first end of the main body and is adapted to be connected to the output shaft of the oscillating power tool. The cutting portion is provided at a second end of the main body and includes a first cutting portion and a second cutting portion. The first cutting portion has a first cutting blade, the second cutting portion has a second cutting blade, and a distance from the second cutting blade to the axis of the output shaft is greater than a distance from the first cutting blade to the axis of the output shaft.

### RELATED APPLICATION INFORMATION

This application claims the benefit of CN 201110155551.1, filed on Jun. 10, 2011, the disclosure of which is incorporated herein by reference in its entirety.

### BACKGROUND

The following generally relates to a cutting element and, more particularly, to a cutting element used on a hand-held oscillating power tool.

A multifunctional machine is a common hand-held oscillating power tool that is used in the industry and its operation principle is that an output shaft moves in an oscillating manner about its own axis. For example, U.S. Pat. No. RE 36,909 discloses a drive structure of an oscillating power tool. The oscillating power tool comprises a housing, a motor disposed in the housing and a main shaft driven by the motor. The main shaft has a rotational axis and an eccentric portion offset from the rotational axis. A transmission fork is driven by the main shaft and operably connected to a working unit. One end of the transmission fork is pivotally connected to an output shaft, the other end thereof is formed with a pair of prongs which are engaged with the eccentric portion of the main shaft. The output shaft is substantially perpendicular to the rotational axis of the main shaft. Rotation of the main shaft about the rotational axis is converted into a pivotal movement of the transmission fork along the output shaft to move the output shaft and drive the working head to work. As different working heads can be mounted on the output shaft, many different operational functions can be achieved. Common working heads comprise straight saw blades, circular saw blades, triangular grinding plates, scrapers and the like and can meet needs for sawing, cutting, grinding, scraping and the like.

In one aspect, when a user mounts a straight saw blade 4′ to an output shaft for operation, where the saw blade 4′ is comprised of a main body 41′, a mounting hole 42′ and a cutting portion 43′ as shown in FIG. 8 and FIG. 9, the mounting hole 42′ that is disposed at a first end of the main body 41′ is used to connect the saw blade 4′ with the output shaft of the oscillating power tool. The cutting portion 43′ is configured as a row of saw teeth. When the user operates the saw blade 4′ to cut a workpiece to be processed, the saw blade 4′ moves in an oscillating manner about the axis of the output shaft. Its oscillation frequency can be set as about 10,000-25,000 times per minute, and the oscillation angle thereof can be set in a range between 0.5° and 7°. In the event of such high-frequency oscillation, when the saw blade 4′ contacts the workpiece, the user usually shakes and cannot perform the cutting operation along a saw path of the saw blade, e.g., the saw blade cannot be held well and may scratch the surface of the workpiece. Thereby a cutting kerf is made relatively wide and the cutting accuracy is affected.

In another aspect, saw teeth made of high-carbon steel are used to cut a wooden workpiece, and saw teeth made of high-speed steel are usually used to cut a metallic workpiece. When the user wants to cut a wooden workpiece and a metal workpiece respectively, he must use two kinds of saw blades and needs to replace the saw blade, which is time-consuming and tiresome and affects the cutting efficiency.

### SUMMARY

The following generally describes a cutting element which is used on an oscillating power tool that has the advantage of effectively preventing scratching of a surface of a workpiece and effectively improving cutting precision and cutting efficiency.

In order to provide these advantages, the cutting element according to an embodiment of the present invention is adapted for an oscillating power tool wherein an output shaft moves in an oscillating manner about its own axis. The cutting element comprises a main body, a mounting hole and a cutting portion acting upon a workpiece to be processed. The mounting hole is disposed at a first end of the main body and is connected to the output shaft of the power tool, the cutting portion is provided at a second end of the main body. The cutting portion comprises a first cutting portion and a second cutting portion, wherein the first cutting portion comprises a first cutting blade, the second cutting portion comprises a second cutting blade, wherein a vertical distance from the second cutting blade to the axis of the output shaft is greater than a vertical distance from the first cutting blade to the axis of the output shaft. In this arrangement, the second cutting blade goes beyond the first cutting blade. When the cutting element contacts the workpiece, first the second cutting blade contacts the workpiece, and the cutting element is effectively positioned so that the cutting element cuts along its saw path; then the first cutting blade contacts the workpiece so that the cutting element will not scratch other surfaces of the workpiece; since the cutting element cuts straightly along its saw path, the kerf formed on the workpiece is relatively narrow so as to effectively improve a cutting precision.

Preferably, the first cutting portion and second cutting portion of the cutting element are disposed in parallel with each other, and the cutting portion comprises at least two first cutting portions, wherein the second cutting portion is located between the two first cutting portions. As such, the middle of the cutting element is positioned, and the cutting element is effectively prevented from jumping in a direction perpendicular to the saw path.

Preferably, a first end and a second end of the main body of the cutting element are provided in parallel with each other. The cutting element is fixed on the output shaft via a fastener. A vertical distance from the second end to the first end of the main body of the cutting element is at least equal to a thickness of the fastener between the first end and the second end.

Furthermore, a material of the first cutting portion may be at least partially different from a material of the second cutting portion. Preferably, a hardness of the material of the first cutting portion is at least partially lower than a hardness of the material of the second cutting portion. For example, the first cutting portion is at least partially made of high-carbon steel, and the second cutting portion is made of high-speed steel. Such arrangement enables the cutting element to cut a wooden workpiece as well as a metal workpiece. The second cutting portion of the cutting element can be used to cut a metal element such as a nail. Upon cutting the wooden workpiece, the second cutting portion of the cutting element positions the cutting element, and effectively prevents the cutting element from jumping in a direction perpendicular to the saw path; after the second cutting portion cuts into the wooden workpiece, the first cutting portion contacts the wood to cut faster, thereby improving the cutting efficiency. In order to achieve the above purposes, preferably, the first cutting portion has a set of first saw teeth, the second cutting portion has a set of second saw teeth, and the number of teeth in the first set of saw teeth is greater than or equal to the number of teeth in the second set of saw teeth; preferably, a tooth distance between teeth in the first set of saw teeth is greater than or equal to a tooth distance between teeth in the second set of saw teeth; preferably a back clearance angle of first set of saw teeth is less than or equal to a back clearance angle of second set of saw teeth.

Certainly, the material of the first cutting portion can be identical with the material of the second cutting portion. At this time, the cutting element facilitates cutting of a workpiece to be processed and is not adapted to cut two kinds of workpieces, namely, a wooden workpiece and a metal workpiece, for example, the first and second cutting portions are both made of a high-carbon steel. Since hardness of high-carbon steel is lower than high-speed steel, the cutting element is adapted to cut the wooden workpiece and not adapted to cut the metal workpiece; conversely, if the first and second cutting portions are both made of high-speed steel, since the number of teeth of he cutting blade made of the high-speed steel is generally less than the number of teeth of the cutting blade made of the high-carbon steel, the cutting efficiency is low when wood is cut. Hence, the cutting element is adapted to cut the metal workpiece and not adapted to cut wood. Therefore, when the first and second cutting portions are made of the identical material, the second cutting portion facilitate positioning of the cutting element, and effectively prevents the cutting element from jumping in a direction perpendicular to the saw path; the first cutting portion and second cutting portion are not adapted to be used to cut different workpieces to be processed.

### BRIEF DESCRIPTION OF THE DRAWINGS

FIG. 1 is a perspective view showing an exemplary cutting element constructed according to the description that follows as mounted to an oscillating power tool;

FIG. 2 and FIG. 5 are respectively a planar schematic view of the cutting element of FIG. 1;

FIG. 3 is a partially enlarged view of a first cutting portion in circle A in FIG. 2;

FIG. 4 is a partially enlarged view of a second cutting portion in circle B in FIG. 2;

FIG. 6 is a cross-sectional view taken along line C-C in FIG. 2;

FIG. 7 is an enlarged view of a saw path of a cutting portion; and

FIG. 8 and FIG. 9 are schematic views of a cutting element found in the prior art.

### DETAILED DESCRIPTION

As shown in FIG. 1, an exemplary cutting element of an electrical tool is illustrated, particularly a cutting element for use in an oscillating power tool. The oscillating power tool comprises a housing 1, a motor and a transmission mechanism (not shown) accommodated in the housing 1. The transmission mechanism comprises a main shaft driven by the motor, the main shaft has a rotational axis and an eccentric portion offset from the rotational axis. A transmission fork is driven by the main shaft and operably connected to a working unit. One end of the transmission fork is pivotally connected to an output shaft, the other end thereof is formed with a pair of prongs which are engaged with the eccentric portion of the main shaft. The output shaft is generally perpendicular to the rotational axis of the main shaft. Rotation of the main shaft about the rotational axis is converted into a pivotal movement of the transmission fork along the output shaft to move the output shaft and drive the working head to work. That is to say, the rotation movement of the motor, via the transmission mechanism, is converted into an oscillation movement of the output shaft 2 about its own axis 3. A cutting element 4 is fixedly mounted on the output shaft 2 via a fastener 5 so that the cutting element 4 moves in an oscillating manner together with the output shaft 2. An oscillation frequency thereof can be set as about 10,000-25,000 times per minute, and the oscillation angle thereof can be set in a range between 0.5° and 7°. The cutting element 4 gradually cuts into an interior of a workpiece through the high-frequency oscillation movement. Those skilled in the art appreciate that the cutting element can also applied to other oscillating power tools and, therefore, need not be limited to the described transmission mechanism.

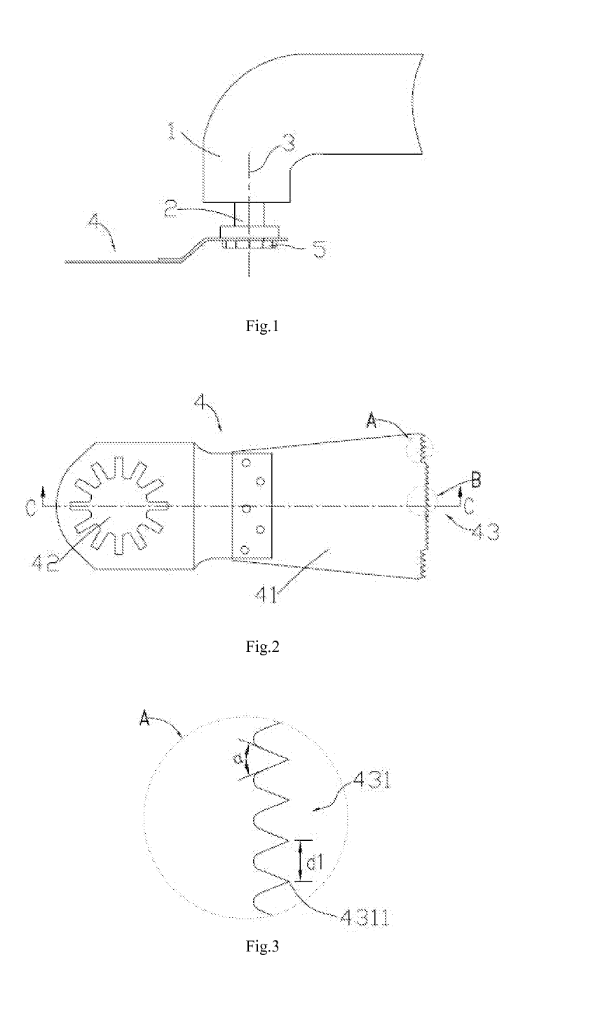

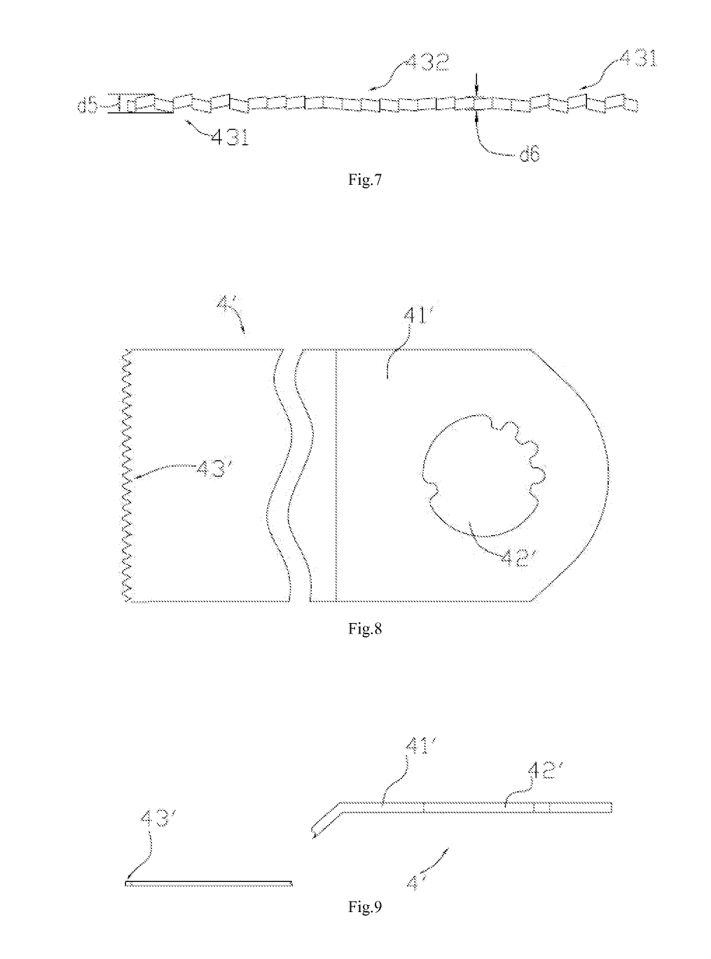

As shown in FIGS. 2-7, the cutting element 4 comprises a main body 41 extending in a longitudinal direction perpendicular to the axis of the output shaft, a mounting hole 42 and a cutting portion 43 for acting upon a workpiece to be processed. The mounting hole 42 is disposed at a first end 411 of the main body and is connected to the output shaft of the oscillating power tool. The cutting portion 43 is provided at a second end 412 of the main body. The cutting portion 43 comprises a first cutting portion 431 and a second cutting portion 432. The first cutting portion 431 comprises a first cutting blade 4311, the second cutting portion 432 comprises a second cutting blade 4321. A distance from the second cutting blade 4321 to the axis 3 of the output shaft is greater than a distance from the first cutting blade 4311 to the axis 3 of the output shaft. That is to say, in a direction perpendicular to and away from the axis 3 of the output shaft, the second cutting portion 432 goes beyond the first cutting portion 431, and they are parallel to each other. When the cutting element 4 contacts the workpiece, the second cutting blade 4321 contacts the workpiece firstly. The cutting element 4 will thereby be effectively positioned so that the cutting element 4 cuts along its saw path. After the second cutting blade 4321 cuts into the workpiece, the first cutting blade 4311 contacts the workpiece so that the cutting element 4 will not scratch other surfaces of the workpiece. Since the cutting element 4 cuts straightly along its saw path, the kerf formed on the workpiece is relatively narrow so as to effectively improve a cutting precision. Furthermore, since the second cutting portion 432 goes beyond the first cutting portion 431, a groove is formed between the second cutting portion 432 and the first cutting portion. When the cutting element 4 carries out a cutting operation, the grooves can receive the materials being cut from the workpiece.

In a preferred embodiment, the cutting element 4 comprises two first cutting portions 431 and one second cutting portion 432. The second cutting portion 432 is located between the two first cutting portions 431. When a user operates the device to which the cutting element 4 is mounted, the second cutting portion at a middle position of the whole cutting portion is enabled to contact the workpiece firstly so that the cutting element is more effectively positioned. Those skilled in the art will appreciate that the function of positioning the cutting element can also be performed by providing the second cutting portion on one side of the whole cutting portion.

Preferably, as shown in FIG. 2 and FIG. 5, the cutting portion of the cutting element 4 has a width, namely, a distance from the cutting portion at the uppermost end to the cutting portion at the lowermost end as shown in the figures. The main body 41 of the cutting element 4 has a first end 411 which has a width, namely, a distance from the uppermost end to the lowermost end of the first end as shown in the figures. The width of the cutting portion is greater than the width of the first end 411. In a saw blade with this width, the positioning role played by the second cutting portion is more apparent, and such saw blade has a higher cutting efficiency than a saw blade with an ordinary width.

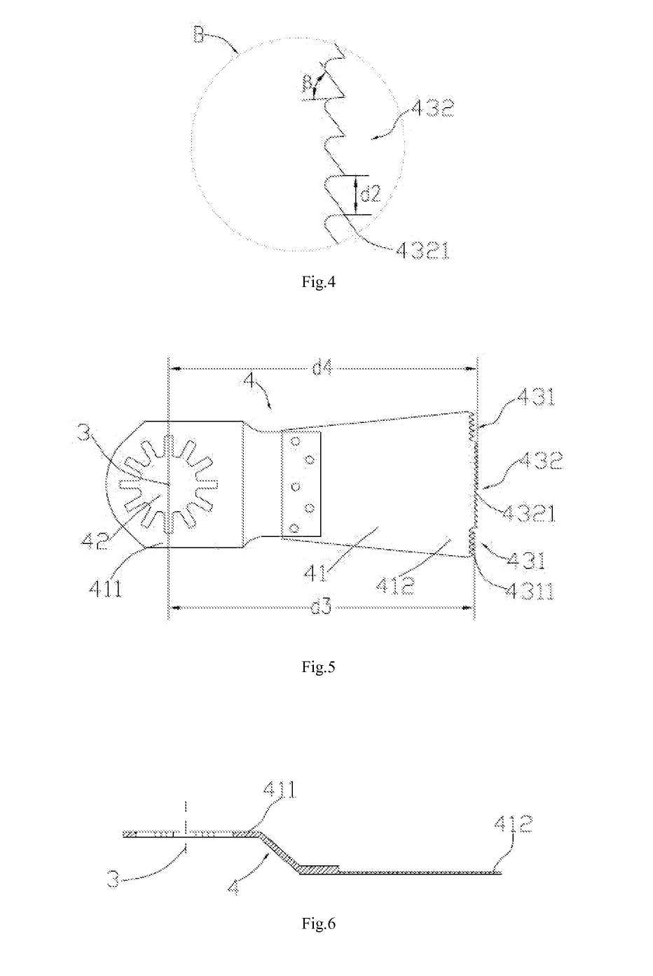

In this preferred embodiment, referring to FIG. 1 and FIG. 6, the first end 411 and the second end 412 of the main body 41 of the cutting element 4 are provided in parallel with each other. A thickness of the fastener 5 between the first end 411 and the second end 412 is less than or equal to a vertical distance between the first end 411 and second end 412. Such arrangement facilitates operation of the oscillating power tool in a relatively narrow and small space.

In another embodiment of the present invention, a material of the first cutting portion 431 is at least partially different from a material of the second cutting portion 432. Preferably, a hardness of the material of the first cutting portion 431 is at least partially lower than a hardness of the material of the second cutting portion 432. For example, the first cutting portion 431 is at least partially made of a high-carbon steel material, and the second cutting portion 432 is made of a high-speed steel material. As well known by those skilled in the art, hardness of high-carbon steel is generally lower than hardness of high-speed steel. As such, the cutting element 4 plays a role of positioning by using the second cutting portion 432, the first cutting portion and the second cutting portion are respectively used to cut different workpieces because the materials of the first cutting portion and the second cutting portion are different. For example, the first cutting portion is at least partially made of high-carbon steel and adapted to cut wood; the second cutting portion is made of high-speed steel and adapted to cut a metallic workpiece such as a nail. In order to carry out better operation for two different kinds of workpieces, preferably, the first cutting portion comprises a set of saw teeth, the second cutting portion comprises a second set of saw teeth, and the number of teeth in the first set of saw teeth is greater than or equal to the number of teeth in the second set of saw teeth; preferably, a tooth distance teeth in the first set of saw teeth is greater than or equal to a tooth distance between teeth in the second set of saw teeth; a back clearance angle α of the first set of saw teeth is less than or equal to a back clearance angle β of the second set of saw teeth. According to this arrangement, when wood is cut, a cutting speed of the first set of saw teeth is faster than the cutting speed of the second set of saw teeth, so the speed of such saw blade is effectively improved as compared with a conventional straight saw blade.

In the further exemplary saw blade, the material of the first cutting portion 431 is identical with the material of the second cutting portion, preferably the hardness of the material of the first cutting portion is identical with the hardness of the material of the second cutting portion, e.g., they are both made of high-carbon steel. At this time, the cutting element 4 can be used to cut wood, the second cutting portion 432 facilitate positioning of the cutting element 4, and effectively prevents the cutting element 4 from jumping in a direction perpendicular to the saw path; when the second cutting portion 432 gradually enters the wood, the first cutting portion 431 comes into contact with the wood so that both the first cutting portion and second cutting portion cut the wood and achieve cutting at a high efficiency.

The above description and figures only illustrate exemplary embodiments of the present invention. The protective scope of the present invention will nevertheless be defined by the appended claims. Non-inventive simple substitutions of partial parts made by those having ordinary skill in the art in the same manner or by simple replacement are considered as falling within the scope of the present invention, for example, it will be understood that the claimed cutting element can be applied to other oscillating power tools whose transmission mechanism is different from the transmission mechanism disclosed in the description.

What is claimed is:

1. A cutting element adapted for use with an oscillating power tool having an output shaft that moves in an oscillating manner about its own axis, the cutting element comprising:
a longitudinally extending main body having a mounting hole adapted for being associated with the output shaft of the oscillating power tool and having a cutting portion for acting upon a workpiece to be processed;
wherein the mounting hole is disposed at a first end of the main body, the cutting portion is provided at a second end of the main body, and the cutting portion comprises a first cutting portion and a second cutting portion, wherein the first cutting portion comprises a first cutting blade, the second cutting portion comprises a second cutting blade, and a distance from the second cutting blade to the axis of the output shaft is greater than a distance from the first cutting blade to the axis of the output shaft.

2. The cutting element according to claim 1, wherein the first cutting portion and second cutting portion are disposed parallel with each other.

3. The cutting element according to claim 1, wherein the cutting portion comprises at least two first cutting portions, and a second cutting portion is located between the two first cutting portions.

4. The cutting element according to claim 1, wherein a first end of the main body is parallel to a second end of the main body.

5. The cutting element according to claim 4, wherein the cutting element is fixed on the output shaft via a fastener and a distance from the first end to the second end is at least equal to a thickness of the fastener between the first end and the second end.

6. The cutting element according to claim 4, wherein the cutting portion has a first width, the first end of the main body has a second width, and the first width is less than the second width.

7. The cutting element according to claim 1, wherein a material of the first cutting portion is at least partially different from a material of the second cutting portion.

8. The cutting element according to claim 7, wherein a hardness of the material of the first cutting portion is at least partially lower than a hardness of the material of the second cutting portion.

9. The cutting element according to claim 1, wherein the first cutting portion comprises a first set of saw teeth, the second cutting portion comprises a second set of saw teeth, and a number of teeth in the first set of saw teeth is greater than or equal to a number of teeth in the second set of saw teeth.

10. The cutting element according to claim 1, wherein the first cutting portion comprises a first set of saw teeth, the second cutting portion comprises a second set of saw teeth, and a tooth distance between teeth of the first set of saw teeth is greater than or equal to a tooth distance between teeth of the second set of saw teeth.

11. The cutting element according to claim 1, wherein the first cutting portion comprises a first set of saw teeth, the second cutting portion comprises a second set of saw teeth, and a back clearance angle of the first set of saw teeth is less than or equal to a back clearance angle of the second set of saw teeth.
